(19) United States
(12) Patent Application Publication
(10) Pub. No.: US 2023/0337710 A1
(43) Pub. Date: Oct. 26, 2023

(54) METHODS FOR PROCESSING PISTACHIO SHELLS

(71) Applicants: Mark Brandon Shiflett, Lawrence, KS (US); Ana Rita Colaco Morais, Lakewood, CO (US)

(72) Inventors: Mark Brandon Shiflett, Lawrence, KS (US); Ana Rita Colaco Morais, Lakewood, CO (US)

(21) Appl. No.: 18/305,573

(22) Filed: Apr. 24, 2023

Related U.S. Application Data
(60) Provisional application No. 63/334,353, filed on Apr. 25, 2022.

(51) Int. Cl. A23N 5/00; A23N 17/02; A23N 17/00; A23K 10/30

(52) U.S. Cl. CPC A23N 5/00; A23N 17/02; A23N 17/001; A23K 10/30

(57) ABSTRACT

The present disclosure provides methods for processing pistachio shells based on cooled, e.g., cryogenic, grinding. In embodiments, such a method comprises grinding raw pistachio shells in a cooled compression milling system, e.g., a cryo-compression milling system, under conditions to provide ground pistachio shells having a D₅₀ particle size in a range of from 10 μm to 600 μm. Animal nutrition products are also provided. In embodiments, an animal nutrition product configured to be ingested by an animal is provided, the animal nutrition product comprising ground pistachio shells having a D₅₀ particle size in a range of from 10 μm to 600 μm.

### CROSS-REFERENCE TO RELATED APPLICATIONS

The present application claims priority to U.S. provisional patent application No. 63/334,353 that was filed Apr. 25, 2022, the entire contents of which are incorporated herein by reference.

### BACKGROUND

Pistachios are a versatile and distinctive variety of nut having a unique flavor and color. The nut (kernel) offers many health benefits and can be eaten raw or used to make sweet and savory dishes. By contrast, there is very little use for the shell of the pistachio fruit. For example, pistachio whole shells are too hard (hardness of approximately 3.5 on the Mohs Hardness scale) for animals to digest and therefore cannot be added to animal feed. Given that half of the weight of the pistachio fruit is the shell, large stockpiles of pistachio shells end up being disposed as solid waste in the U.S. each year.

### SUMMARY

The present disclosure provides methods for processing pistachio shells based on cooled, e.g., cryogenic, grinding. In embodiments, a method for processing pistachio shells comprises grinding raw pistachio shells in a cooled compression milling system, e.g., a cryo-compression milling system, under conditions to provide ground pistachio shells having a D₅₀ particle size in a range of from 10 μm to 600 μm.

Animal nutrition products are also provided. In embodiments, an animal nutrition product configured to be ingested by an animal is provided, the animal nutrition product comprising ground pistachio shells having a D₅₀ particle size in a range of from 10 μm to 600 μm.

Other principal features and advantages of the disclosure will become apparent to those skilled in the art upon review of the following drawings, the detailed description, and the appended claims.

### DETAILED DESCRIPTION

The present disclosure provides methods for processing raw pistachio shells. The term “raw” is used to refer to the pistachio shells prior to processing using the present methods. The raw pistachio shells have generally not been subjected to any prior processing technique, including any type of physical and/or chemical processing technique. The present methods comprise grinding the raw pistachio shells in a cooled, e.g., cryogenic, milling system. Embodiments of the methods are able to achieve ground pistachio shells having desirable properties, e.g., high release, high accessibility, and low oxidation of the polyphenols in the pistachio shells. In addition, cryo-cooling of raw pistachio shells helps to reduce oil build-up in components (e.g., grinding mills) in contact with the shells, which reduces clogging and improves long-term production.

The type of cryogenic milling system and the conditions used during its operation are generally selected to achieve ground pistachio shells having one or more of the characteristics described below, e.g., reduction of pistachio allergen content, increase in ruminant digestibility, and polyphenol release within the ranges disclosed herein. In embodiments, however, the cryogenic milling system comprises a solenoid and a container configured to contain the moving solenoid and the raw pistachio shells. In embodiments, the cryogenic milling system is configured to apply a compressive mechanical force (e.g., via a piston, rotor, hammer, or other impact device) on the raw pistachio shells. In embodiments, the force is sufficient to induce a change in the physical structure of the raw pistachio shells, including inducing crystal defects and polymorphic transformations. Cryogenic milling systems configured to apply a compressive mechanical force may be referred to as a “cryo-compression milling system.” The conditions used during the operation of the cryogenic milling system include parameters such as grinding temperature, cool down time, and grinding time. In embodiments, liquid nitrogen is used as a cryogenic fluid to cool the raw pistachio shells below their embrittlement temperature during cool down. After reaching the embrittlement temperature, the grinding step is initiated. The grinding temperature is that of the liquid nitrogen (−196° C.). However, other cooling techniques (utilizing liquid water, CO₂, air, and other cooling media) and, therefore other grinding temperatures may be used. In these embodiments, the milling system may be referred to as a cooled compression milling system which may be configured to apply the compressive mechanical force as described above. In addition, the term “cryogenic” and the like throughout the present disclosure may be replaced with “cooled.”

The grinding time is generally selected to achieve a desired D₅₀ particle size for the ground pistachio shells. D₅₀ particle size refers to a diameter at which 50% of the sample (on a volume basis), here, the ground pistachio shells, is comprised of particles having a diameter less than said diameter value. The D₅₀ particle size may be measured as described in the Examples below. In embodiments, the ground pistachio shells are characterized by a D₅₀ particle size from 10 μm to 600 μm. This includes from 20 μm to 250 μm, from 30 μm to 200 μm, and from 50 μm to 100 μm. As demonstrated in the Examples, below, it has been determined that these ranges are associated with very high levels of polyphenol release as compared to D₅₀ particle sizes outside of these ranges. In particular, a D₅₀ particle size in a range of from 50 μm to 100 μm has been found to promote the release of higher concentrations of polyphenols.

The raw pistachio shells being processed by the present methods are generally in the form of intact, whole shells (although this does not mean that every shell being processed need be whole; partially intact shells may be included). The raw pistachio shells may be characterized by their moisture content. In embodiments, the moisture content is less than 10%. This includes having a moisture content in a range from 2 to 10%. In embodiments, the raw pistachio shells are processed alone without the addition of any other components. In other embodiments, the raw pistachio shells may be combined with another component(s). For example, the raw pistachio shells may be combined with any of the cooling media described above (e.g., liquid nitrogen, liquid CO₂, etc.), e.g., the raw pistachio shells and the cooling media are provided together, e.g., as a slurry, to be processed by the present methods.

The ground pistachio shells provided by the present methods are characterized by the amount of polyphenol released therefrom. Polyphenol release may be measured as described in the Examples, below. The amount of polyphenol released may refer to the sum of free and bound polyphenol. Bound polyphenol refers to the polyphenols not affected by gastrointestinal digestion and are only released in colonic fermentation, while free polyphenol refers to the polyphenols that are quickly absorbed by the small intestine. In embodiments, the amount of polyphenol (free and unbound) released from the ground pistachio shells is at least 11%. These percentages refer to the (weight of free and bound polyphenol released from the ground pistachio shells)/(total weight of the ground pistachio shells)*100.

The ground pistachio shells provided by the present methods may be characterized by their allergen content. In embodiments, the ground pistachio shells have a pistachio allergen content of not more than 1240 ppm. This includes having an allergen content in a range from 1500 ppm to 1240 ppm. However, higher allergen content can occur.

The ground pistachio shells may also be characterized by their digestibility, including ruminant digestibility. Ruminant digestibility may be measured as described in the Examples, below. In embodiments, the ground pistachio shells have a ruminant digestibility of at least 58%. This includes having a ruminant digestibility in a range from 14 to 58%.

The ground pistachio shells may be used for a variety of purposes. However, due to the high amount of polyphenol released therefrom and digestibility, they are particularly useful alone, or when combined with other compounds, as an animal nutrition product. Thus, also encompassed by the present disclosure are such animal nutrition products comprising ground pistachio shells, including ground pistachio shells having any of the characteristics described herein. The term “animal nutrition product” encompasses products which are configured to be ingested by an animal (without substantial harm to the animal), including domestic pets, pigs, poultry, cattle, cows, and fish and encompass products such as animal supplements, food, and the like. In an animal nutrition product comprising the ground pistachio shells in addition to other compounds, the ground pistachio shells may be present in any suitable amount, e.g., from 1 to 30 weight %. When additional compounds are present, any compound suitable for animal ingestion may be present in any suitable amount. Methods of using the animal nutrition products are also encompassed by the present disclosure.

### EXAMPLES

### Example 1: Effect of Cryogrinding Time on the Extraction of Polyphenols from Raw Pistachio Shells

Dry whole pistachio shells (moisture content less than 10%) were added to a vial that contained a solenoid. The vial containing pistachio shells and the solenoid were immersed in liquid nitrogen. After 1 minute of cooling down in liquid nitrogen, the solenoid started moving the cold nut shells back and forth inside the vial, grinding the shells of the sample down to smaller particles. One (1) and 120 minutes of total cryogrinding time resulted in D₅₀ particle sizes of approximately 300 and 10 μm, respectively, as determined by laser diffraction analysis by using a Malvern Mastersizer 2000 with Hydro 2000S disperser. For this measurement, water was used as the dispersant with 1.330 as dispersant Refractive Index (RI). The ground pistachio shells were analyzed in a size range from 0.020 μm to 2000 μm. To measure the D₅₀ particle size, a sample was wetted with isopropanol and water, shaken, and dispersed in 0.01% sodium dodecyl sulfate solution with 30 seconds of on-board sonication. The sample was added to the Hydro unit, which disperses ground pistachio shells and circulates them through the optical cell, where the size is determined. D₅₀ particle size is calculated with the Fraunhofer approximation, which is justified by the relative lack of micron-sized particles. Depending on the particle size, samples are sieved prior to laser diffraction analysis.

After cryogenic milling, the ground pistachio shell samples were tested for polyphenol and ORAC (Oxygen Radical Absorbance Capacity) content. ORAC is a measurement that indicates how much antioxidant is in the material. The analytical protocol to measure free and bound polyphenol content (total polyphenol content is the sum of free and bound polyphenol) was as follows: 10 g of ground pistachio shells was blended to 20 mL of 80% acetone and mixed for 1 hour. The mixture was centrifuged at 3,900 rpm for 10 min. The supernatant was collected in a separated pre-weighted flask. The process was repeated two times by adding 20 mL of 80% acetone. All the supernatants were collected and dried under nitrogen gas. The residue (pellet) underlying the supernatant was saved and used for bound polyphenol extraction. After drying with nitrogen gas, weight of the dried extract (dried supernatant) was obtained and the concentrate was dissolved in methanol:water (80:20) solvent for quantification of free polyphenol. The residue (pellet) from above was dried and divided in two equal parts. One part underwent an alkaline hydrolysis method by adding eight volumes of 2.5 N NaOH solution to the residue, mix thoroughly and incubate reflux at 80° C. for 2 hours. The mixture was then acidified to pH 2.0 with HCl and centrifuged for 10 min at 3,900 rpm. The supernatant was collected. Partition with equal volume of ethyl acetate and collection of the upper phase was carried out. The process was repeated two times from acidification of the mixture to pH 2 step. All the upper phases were collected and dried under nitrogen gas. After drying, the weight of the dried extract was obtained and the concentrate was dissolved in methanol for quantification purposes.

TABLE 1
Effect of particle size on total polyphenol content. Total
polyphenol content refers to the sum of the free polyphenol
and the bound polyphenol as measured above.

| Particle size (D₅₀) in microns | Total polyphenol content (%) |
|---|---|
| 300 | 1.30 |
| 10 | 10.62 |

ORAC results were as follows. Total ORAC (umole TE/g) 199.8; HORAC (umole TE/g) 11.6; NORAC (umole TE/g) 5; CLORAC (umole TE/g) 1.1; SORAC (umole TE/g) 42.09; SOAC (umole TE/g) 1.54; ORAC-Hydro (umole TE/g) 38.53.

### Example 2: Effect of Cryogrinding Time on the Containerboard-Based Pistachio Shells Properties

Dry whole pistachio shells (moisture content less than 10%) were added to a vial that contained a solenoid. The vial containing pistachio shells and the solenoid were immersed in liquid nitrogen. After 1 minute of cooling down in liquid nitrogen, the solenoid started moving the cold nut shells back and forth inside the vial, grinding the shells of the sample down to smaller particles. One (1) and 120 minutes of total cryogrinding time resulted in D₅₀ particle sizes of approximately 300 and 10 μm, respectively, as described above. After cryogenic milling, the ground pistachio shell samples were added to container board handsheets (at 10 weight % ground pistachio shells) via hot pressing. Various mechanical and optical properties were measured and compared with handsheets made of recycled paper (control). The results are shown in Tables 2 and 3.

TABLE 2
Effect of particle size on the mechanical properties
of handsheet-based pistachio shells.

| | Particle size (D₅₀) in microns | | |
|---|---|---|---|
| Mechanical properties | 100 | 10 | Control |
| Density (kg/m³) | 217 | 425 | 470 |
| Tensile Index (N m/g) | 28.51 | 32.21 | 35.09 |
| Tear Index (mN m²/g) | 10.57 | 5.76 | 12.00 |
| Thickness (μm) | 298 | 150.8 | 138 |

TABLE 3
Effect of particle size on the optical properties
of handsheets-based pistachio shells.

| | Particle size (D₅₀) in microns | | |
|---|---|---|---|
| Optical properties | 100 | 10 | Control |
| Air Permeability | 4.9 | 3.0 | 5.4 |
| (sec/100 mL air) | | | |
| Brightness | 16.8 | 17.9 | 17.9 |

### Example 3: Effect of Cryogrinding Time on the Ruminant Digestibility

Dry whole pistachio shells (moisture content less than 10%) were added to a vial that contained a solenoid. The vial containing pistachio shells and the solenoid were immersed in liquid nitrogen. After 1 minute of cooling down in liquid nitrogen, the solenoid started moving the cold nut shells back and forth inside the vial, grinding the shells of the sample down to smaller particles. Total cryogrinding times of 1 and 40 minutes resulted in D₅₀ particle sizes of approximately 300 and 30 μm, respectively, determined as described above. After cryogenic milling, the in vitro ruminant digestibility was determined for each sample, with the results shown in Table 4, below. The procedure for testing in vitro ruminant digestibility has been set forth in the Appendix of U.S. Ser. No. 63/334,353, filed Apr. 25, 2022, the entire contents of which are incorporated herein by reference. As shown in Table 4, below, particle size affects digestibility.

TABLE 4
Effect of cryogrinding time on pistachio
shells' ruminant digestibility.

Particle size (D₅₀) in microns

| | 300 | 30 |
|---|---|---|
| Digestibility | 14.09 | 56.85 |

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

All numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A method for processing pistachio shells, the method comprising grinding raw pistachio shells in a cooled compression milling system under conditions to provide ground pistachio shells having a D₅₀ particle size in a range of from 10 μm to 600 μm.

2. The method of claim 1, wherein the cooled compression milling system makes use of a cooling medium selected from liquid nitrogen, liquid carbon dioxide, liquid water, and air.

3. The method of claim 2, wherein the cooling medium is liquid nitrogen.

4. The method of claim 1, wherein the conditions comprise a grinding time in a range of from 1 to 120 min.

5. The method of claim 1, wherein the raw pistachio shells have a moisture content of less than 10%.

6. The method of claim 1, wherein the conditions comprise a grinding time in a range of from 1 to 120 min and the raw pistachio shells have a moisture content of less than 10%.

7. The method of claim 1, wherein the ground pistachio shells have a total polyphenol content of at least 11%.

8. The method of claim 1, wherein the ground pistachio shells have a ruminant digestibility of at least 56.85%.

9. The method of claim 1, wherein the ground pistachio shells have a total polyphenol content of at least 11% and a ruminant digestibility of at least 56.85%.

10. The method of claim 1, wherein the conditions comprise a grinding time in a range of from 1 to 120 min, the raw pistachio shells have a moisture content of less than 10%, and the ground pistachio shells have a total polyphenol content of at least 11% and a ruminant digestibility of at least 56.85%.

11. The method of claim 10, wherein the cooled compression milling system makes use of liquid nitrogen as a cooling medium.

12. The method of claim 1, wherein the raw pistachio shells are combined with a cooling medium.

13. The method of claim 1, further comprising forming an animal nutrition product configured for ingestion by an animal from the ground pistachio shells.

14. An animal nutrition product configured to be ingested by an animal, the animal nutrition product comprising ground pistachio shells having a D₅₀ particle size in a range of from 10 μm to 600 μm.

15. The animal nutrition product of claim 14, wherein the ground pistachio shells have a total polyphenol content of at least 11%.

16. The animal nutrition product of claim 14, wherein the ground pistachio shells have a ruminant digestibility of at least 56.85%.

17. The animal nutrition product of claim 14, wherein the ground pistachio shells have a total polyphenol content of at least 11% and a ruminant digestibility of at least 56.85%.

18. A method of treating an animal, the method comprising providing the animal nutrition product of claim 14 to an animal for ingestion by the animal.
